(19) United States
(12) Patent Application Publication
(10) Pub. No.: US 2010/0252124 A1
(43) Pub. Date: Oct. 7, 2010

(54) VALVE FOR A MICROFLUIDIC SYSTEM

(75) Inventors: Ralph Kurt, Eindhoven (NL); Emiel Peeters, Eindhoven (NL); Roel Penterman, Eindhoven (NL); Martin Ouwerkerk, Geldrop (NL); Christopher James Backhouse, Edmonton (CA)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/743,838

(22) PCT Filed: Nov. 18, 2008
(86) PCT No.: PCT/IB08/54828

§ 371 Date: May 20, 2010

(30) Foreign Application Priority Data
Nov. 22, 2007 (EP) 07121301.1

(51) Int. Cl. F16K 49/00

(52) U.S. Cl. 137/341

(57) ABSTRACT

The invention relates to a valve for opening and closing a channel (3) of a microfluidic system, respectively. According to the invention, the valve comprises an actuation medium (2) that undergoes a volume change with changing temperature; and a heater arrangement (5) for generating a temperature gradient in the actuation medium (2) with respect to the actuation medium's (2) distance relative to the channel (3); wherein due to an expansion or a contraction of the actuation medium (2) the channel (3) is closed or opened, respectively. When the heater arrangement (5) is activated in such a way that a higher temperature is generated in the actuation medium (2) which is nearer to the channel (3) and a lower temperature is generated in the actuation medium (2) which is further away from the channel (3) the valve can be closed and vice versa. Accordingly, such a valve for a microfluidic system is provided which can be reliably actuated during a long time of use.

### FIELD OF THE INVENTION

The invention relates to the field of microfluidic systems, especially to valves for opening and closing a channel of a microfluidic system, respectively.

### BACKGROUND OF THE INVENTION

Integrated portable microbiological systems, especially for rapid digital diagnostic tests (RDT), require independently operating microvalves to control the transport of liquid samples for complex and parallel functions. However, conventional microvalves are cumbersome to fabricate due to multilayer fabrication steps or the need for external pressure sources to operate them.

Key elements in such systems are integrated active valves which preferably can be actuated without external pumps, enabling portable biochemical systems for point-of-care/need testing. Such systems are often based on thermal expansion/compression of melting/crystallization of polyethylene glycol (PEG) or paraffin. However, the performance of microvalves based on thermal expansion/compression of melting/crystallization of polyethylene glycol (PEG) already alters after a few switching cycles, and the reproducibility is limited due to random and uncorrelated crystallization, formation of voids and cracks, typically along the grain boundaries, and delamination of PEG from the substrate.

From WO 2005/107947 A1 a valve for controlling fluid flow in a microfluidic device is known. This valve comprises a chamber formed on a substrate, a heating coil and a valve material contained in the chamber. When the valve is to be closed, the heating coil is activated causing the valve material to expand out of the chamber through a neck portion and into the main channel, thus, blocking the channel. The valve material can be paraffin wax which is caused to melt by the heating coil. On melting, the melted paraffin wax flows into the main channel where it cools and solidifies. However, this valve will only work for one single event since the wax will not come back into the chamber.

### SUMMARY OF THE INVENTION

It is an object of the invention to provide such a valve for a microfluidic system which can be reliably actuated during a long time of use.

This object is achieved by a valve for opening and closing a channel of a microfluidic system, respectively, the valve comprising:

an actuation medium that undergoes a volume change with changing temperature; and

a heater arrangement for generating a temperature gradient in the actuation medium with respect to the actuation medium's distance relative to the channel; wherein

due to an expansion or a contraction of the actuation medium the channel is closed or opened, respectively.

Accordingly, it is an important feature of the invention that the valve comprises a heater arrangement capable of generating a temperature gradient at least in one direction in the actuation medium. This means that the temperature in the actuation medium changes depending on the distance from the channel which is to be closed by the valve.

In general, the actuation medium might be provided in a reservoir which is in direct contact with the channel, i.e. which is not sealed from the channel. However, according to a preferred embodiment of the invention, the actuation medium is provided in a medium reservoir which is sealed relative to a channel. Thus, it can be guaranteed that the actuation medium will not stick to the walls of the channel and, thus, can be automatically removed from the channel for opening the valve again.

In general, the actuation medium can be sealed from the channel in many different ways. However, according to a preferred embodiment of the invention, the medium reservoir is sealed relative to the channel by an elastomeric membrane. Though throughout the present description and claims the term “membrane” is used, this does not suggest that it has to be permeable. According to a further preferred embodiment of the invention, the membrane comprises a thickness from equal or more than 50 μm to equal or less than 500 μm, preferably from equal or more than 100 μm to equal or less than 300 μm. Further, it is especially preferred that the membrane comprises or is made of polydimethyl siloxane (PDMS). Furthermore it is preferred that it is impermeable for aqueous fluids and inert to biological species.

The heater arrangement can be designed in different ways. However, according to a preferred embodiment of the invention, the heater arrangement comprises at least two heaters, preferably more than two heaters and most preferably four or more than four heaters. The heaters can be arranged in multiple different ways. Especially, a combination of one or multiple local heater(s) with one or more external heater(s) can be use, too. According to a preferred embodiment of the invention, the heaters of the heater arrangement are arranged along the medium reservoir, preferably laterally next to each other, with increasing distance to the channel. Especially, the arrangement of the heaters as well as the form of the reservoir can be a linear or a curved arrangement, wherein the latter means that the reservoir does not follow a rectangular shape but some kind of bent shape and/or that the heaters are not arranged along a straight line but along a curved line.

The heaters of the heater arrangements can be designed in different ways, especially for the heaters, as well as for drivers and sensors, LTPS can be used. According to a preferred embodiment of the invention, the heaters are comprised of resistive heater elements, preferably as thin film heater elements. This provides the possibility to actuate the valve electronically. This way, the need for external pressure sources for valve actuation is eliminated which enables the realisation of portable biochemical systems for point-of-care testing, for example.

Generally, no temperature sensors or other sensors are necessary for the valve. However, according to a preferred embodiment of the invention, at least one temperature sensor is provided, preferably multiple temperature sensors are provided, especially for detecting the temperature or the temperature gradient of the actuation medium, respectively. Especially with respect to this, according to a preferred embodiment of the invention, a feedback loop, preferably a closed feedback loop, is provided for controlling the temperature of the actuation medium. Especially this means that the heaters of the heater arrangement can be activated in dependence of the temperature or temperature gradient detected by the temperature sensor or sensors, respectively. Another possible feedback loop is via a pressure sensor in the channel. Via measuring the pressure, the temperature in the actuation medium is adjusted, e.g. to realize constant pressure or to control the flow.

According to a preferred embodiment of the invention, the valve is controlled by a flow meter which is arranged in the channel of the microfluidic system. Said flow could also be measured indirectly by measuring flow related properties, like temperature, heat, conductivity, number of particles that flow through the channel etc.

Further, different actuation media can be used. However, according to a preferred embodiment of the invention, such an acuation medium is provided that undergoes a preferably reversable phase transition, preferably from solid to liquid, when changing the temperature due to heating by the heater arrangement. This means that according to this preferred embodiment of the invention, when the temperature drops due to no more heating of the heater arrangement, there will be a reversable phase transition from liquid to solid again. Typically, these phase transitions are also transitions from amorphous (liquid) to crystalline (solid) and vice versa. Others are e.g. from liquid to gas (perfluorocarbons) and vice versa.

Different temperature regions for phase transition of the actuation medium can be used. According to a preferred embodiment of the invention, the actuation medium undergoes phase transition in a range from equal or more than 30° C. to equal or less than 80° C., preferably from equal or more than 40° C. to equal or less than 70° C.

According to a further preferred embodiment of the invention, as an actuation medium a phase change material (PCM) is used. Especially the follow materials are preferred: polyethylene glycol (PEG), salt hydrides, fatty acids, esters, paraffine, octadecane, and/or ionic liquids and mixtures thereof.

Preferably, such materials are used with which volume changes from 10 to 30% can be achieved. Further, the transition temperature for the phase transition is tuned to a desired temperature. Suitable additives for tuning the transition temperature are oligomers like tripropylene glycol or dedicated organic solvents, which preferably do not evaporate/diffuse through an elastomeric membrane like a membrane made of PDMS.

Generally, only one material for the actuation medium is necessary. However, according to a preferred embodiment of the invention, the actuation medium is comprised of at least two materials having different phase transition temperatures, especially different melting temperatures and/or different specific thermal heat capacities, wherein the two materials preferably are arranged adjacent to each other. This way, the creation of a temperature gradient and the formation of a well controlled melting/crystallization front can be further improved.

When going from liquid to crystalline state, some materials e.g. PEG exhibit long crystallization times due to insufficient nucleation site formation. Nucleation and growth of crystals can be enhanced by adding nucleation moieties to the actuation medium. For example, when two types of PEG of different molecular weights (Mw) are used (the larger the Mw, the higher the melting temperature) and the temperature generated by the heaters is kept below the Tm of the high Mw PEG, the high Mw PEG crystals act as nucleation sites for the low Mw PEG.

Above mentioned object is further addressed by a method for operating a valve as described above, comprising the following steps:

activating the heater arrangement in such a way that first a higher temperature is generated in the part of the actuation medium which is nearer to the channel and a lower temperature is generated in the part of the actuation medium which is further away from the channel, and then, subsequently, a higher temperature is also generated parts of the actuation medium which are further away from the channel, for closing the valve

and/or

activating the heater arrangement in such a way that first a lower temperature is generated in the part of the actuation medium which is further from the channel and a higher temperature is generated in the part of the actuation medium which is close to the channel, and then, subsequently, a lower temperature is also generated in parts of the actuation medium which are closer to the channel, for opening the valve.

Further, it is also preferred that, when the heater arrangement comprises multiple heaters and an elastomeric membrane is used, the bulging of the elastomeric membrane is tuned by the number of activated heaters and/or the temperature generated in the actuation medium by the heaters. Also the differential pressure capability of the valve can be tuned in this way as the volume expansion of the actuation medium can be adjusted.

A system comprising a valve as described above is preferably used in one or more of the following applications:
microfluidic biosensors for molecular diagnostics;
integrated part of microfluidic biosensors, especially for pre-amplification or amplification, filtering, mixing and/or detection;
detection of proteins and nucleic acids in complex biological mixtures, especially for on-site testing and/or for diagnostics in centralized laboratories;
medical diagnostics, especially protein diagnostics for cardiology, infectious diseases and/or oncology;
food diagnostics;
environmental diagnostics; and
metabolomics.
flow control

### BRIEF DESCRIPTION OF THE DRAWINGS

These and other aspects of the invention will be apparent from and elucidated with reference to the embodiments described hereinafter.

In the drawings:

FIG. 1a shows a schematic cross section through a valve according to a first preferred embodiment of the invention in its opened state,

FIG. 1b shows a schematic cross section through a valve according to the first preferred embodiment of the invention in its closed state,

FIG. 2 shows a schematic top view of a valve according to a second preferred embodiment of the invention,

FIG. 3a shows a sequence of schematic top views illustrating the closing of the valve according to the second preferred embodiment of the invention,

FIG. 3b shows a sequence of schematic top views illustrating the opening of the valve according to the second preferred embodiment of the invention; and

FIG. 4 shows a schematic diagram of a valve according to a third preferred embodiment of the invention.

### DETAILED DESCRIPTION OF EMBODIMENTS

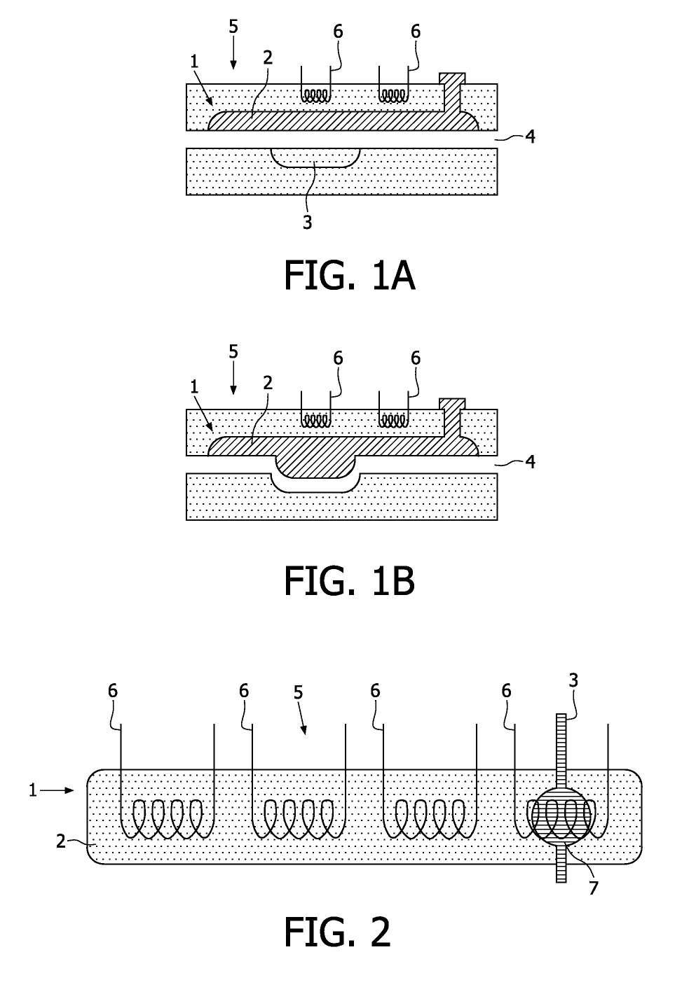

From FIGS. 1a and 1b a valve according to a first preferred embodiment of the invention can be seen in a schematic side view. The valve comprises a medium reservoir 1 which contains an actuation medium 2 as polyethylene glycol. The actuation medium 2 in the medium reservoir 1 is sealed from the channel 3 which is to be closed and opened by the valve, respectively, with the help of an elastomeric membrane 4 made of PDMS and having a thickness between 100 and 300 μm.

As can be further seen from FIGS. 1a and 1b, a heater arrangement 5 comprising two heaters 6 is provided. The heaters 6 of the heater arrangement 5 of the preferred embodiments shown here are designed as thin film heater elements, enabling the valve to be controlled electronically. By actuating these heaters 6, a phase transition from solid/crystalline to liquid/amorphus and, thus, a volume expansion can be achieved, resulting in the possibility to close channel 3 by heating the heaters 6 of the heater arrangement 5 and to open the channel 3 again when heaters 6 are not actuated any more.

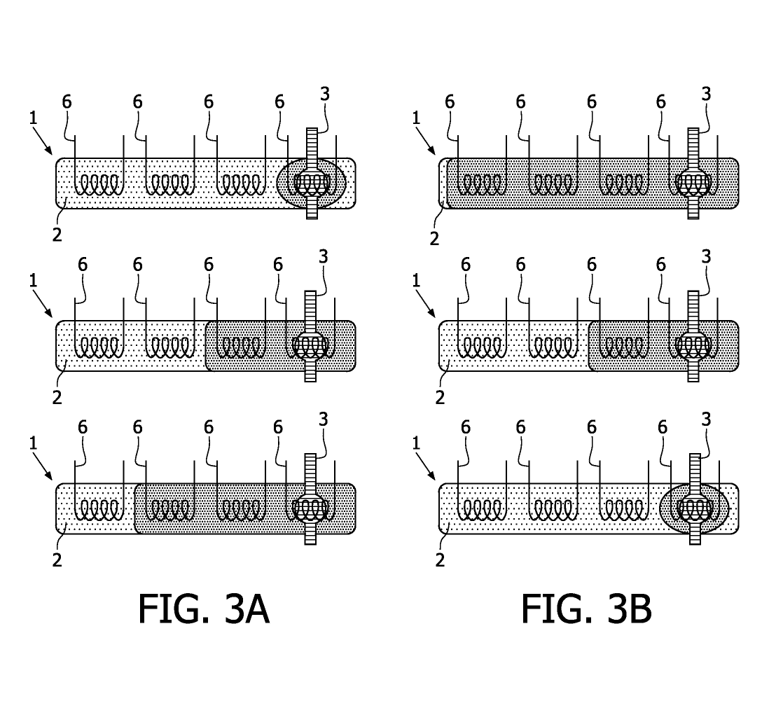

This method for closing and opening the channel 3 will be explained more in detail with reference to FIGS. 2 and 3a, b which show a valve according to a second preferred embodiment of the invention. These Figures are schematic top views of such a valve, that is generally designed as the valve shown in FIGS. 1a, b, whereby instead of a heater arrangement 5 with two heaters 6, four heaters 6 are provided. This way, heating of the actuation medium 2 and thus controlling the valve can be done even more precisely.

FIG. 2, which is a schematic top view onto the valve according to a second preferred embodiment of the invention shows that the channel 3 comprises an area with a clearance 7. The width of the medium reservoir 1 according to the second preferred embodiment of the invention is approximately 250 μm, and its length is approximately 1000 μm. Perpendicularly to the channel 3 and beginning over the clearance 7, the heaters 6 of the heater arrangement 5 are provided laterally next to each other and with increasing distance to channel 3. The heater arrangement 5 with the four heaters 6 extends along the medium reservoir 1 in which the actuation medium 2 is provided. With its one end, the medium reservoir 1 extends over the clearance 7 of the channel 3.

As can be seen from FIG. 3a, closing the valve is achieved as follows: By subsequently addressing the heaters 6 of the heater arrangement 5 from right to left, a melting front of the solid actuation medium 2 in the medium reservoir 1 is generated since the temperature of the actuation medium 2 rises beyond the transition temperature for the solid/liquid phase transition. Since the actuation medium 2 melts, its volume increases and the elastomeric membrane 4 bulges into the clearance 7 of the channel 3. As more and more of the actuation medium 2 melts, bulging increases, and finally the clearance 7 of the channel 3 is totally filled which means that the valve closes the channel 3.

In order to open the channel 3 again, as can be seen from FIG. 3b, heating of the heaters 6 of the heater arrangement is successively stopped, beginning at the left side of the medium reservoir 1. This way, actuation medium 2 solidifies from left to right and, thus, the volume of the actuation medium 2 decreases. As a result, the bulging of the elastomeric membrane 4 into the clearance 7 of the channel decreases and finally, the channel 3 is opened again.

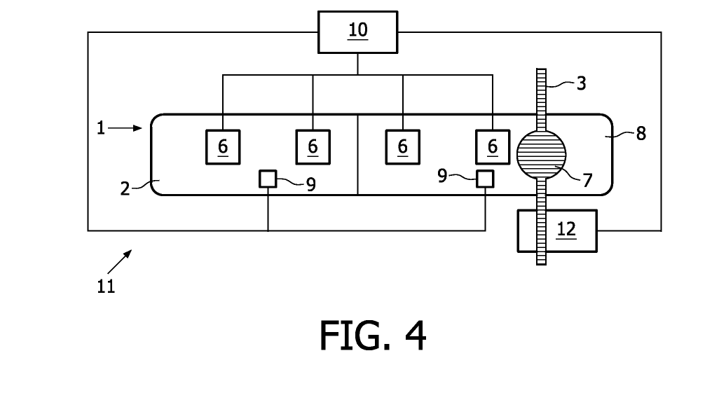

From FIG. 4 a schematic diagram of a valve according to a third preferred embodiment of the invention can be seen. According to this embodiment, besides the actuation medium 2 a second actuation medium 9 is provided. Both actuation media 2, 8 are such media that undergo a reversible phase transition from solid to liquid, when changing the temperature due to heating. Further, the actuation media are comprised of two materials having different phase transition temperatures, i.e. different melting temperatures and different specific thermal heat capacities. As can be seen from FIG. 4, the two materials are arranged adjacent to each other, wherein the one actuation medium 2 is located further away from the channel 3 and the second actuation medium is located nearer to the channel 3. This way, the creation of a temperature gradient and the formation of a well controlled melting/crystallization front can be further improved.

Further, according to the third preferred embodiment of the invention, two temperature sensors 9 for detecting the temperature gradient of the actuation media 2, 8 are provided. The temperature signals from the temperature sensors 9 are fed to a heating controller 10 which controls the heaters 6, two of which are provided for the one actuation medium 2 and two of which are provided for the second actuation medium 8. Thus, a closed feedback loop 11 for controlling the temperature gradient of the actuation media 2, 8 is achieved.

Further, according to the third preferred embodiment of the invention, a flow meter 12 is arranged in the channel 3. This flow meter 12 can also be used for controlling the valve: The flow meter signal is fed to the heating controller 10, enabling control of the heaters 6 and, thus, of the temperature gradient in the actuation media 2, 8 with respect to the flow in the channel 3.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A valve for opening and closing a channel (3) of a microfluidic system, respectively, the valve comprising:
an actuation medium (2) that undergoes a volume change with changing temperature; and
a heater arrangement (5) for generating a temperature gradient in the actuation medium with respect to the actuation medium's (2) distance relative to the channel (3); wherein
due to an expansion or a contraction of the actuation medium (2) the channel (3) is closed or opened, respectively.

2. A valve according to claim 1, wherein the actuation medium (2) is provided in a medium reservoir (1) which is sealed relative to the channel (3) by an elastomeric membrane (4).

3. A valve according to claim 1, wherein the heater arrangement (5) comprises at least two heaters (6), preferably more than two heaters (6) and most preferably four or more than four heaters (6).

4. A valve according to claim 1, wherein at least one temperature sensor (9) is provided, preferably multiple temperature sensors (9) are provided, for detecting the temperature or the temperature gradient of the actuation medium (2), respectively.

5. A valve according to claim 1, wherein a feedback loop (11), preferably a closed feedback loop (11), is provided for controlling the temperature of the actuation medium (2).

6. A valve according to claim 1, wherein the valve is controlled by a flow meter (12) arranged in the channel (3) of the microfluidic system.

7. A valve according to claim 1, wherein such an actuation medium (2) is provided that undergoes a preferably reversible phase transition, preferably from solid to liquid, when changing the temperature due to heating by the heater arrangement (5).

8. A valve according to claim 7, wherein the actuation medium (2, 8) is comprised of two materials having different phase transition temperatures, especially different melting temperatures and/or different different specific thermal heat capacities, the two materials preferably being arranged adjacent to each other.

9. A method for operating a valve according to claim 1, comprising the following steps:
activating the heater arrangement (5) in such a way that first a higher temperature is generated in the part of the actuation medium (2) which is nearer to the channel (3) and a lower temperature is generated in the part of the actuation medium (2) which is further away from the channel (3), and then, subsequently, a higher temperature is also generated parts of the actuation medium (2) which are further away from the channel (3), for closing the valve and/or
activating the heater arrangement (5) in such a way that first a lower temperature is generated in the part of the actuation medium (2) which is further from the channel (3) and a higher temperature is generated in the part of the actuation medium (2) which is close to the channel (3), and then, subsequently, a lower temperature is also generated in parts of the actuation medium (2) which are closer to the channel (3), for opening the valve.

10. A system comprising a valve according to claim 1, the system being used in one or more of the following applications:
microfluidic biosensors for molecular diagnostics;
integrated part of microfluidic biosensors, especially for pre-amplification or amplification, filtering, mixing and/or detection;
detection of proteins and nucleic acids in complex biological mixtures, especially for on-site testing and/or for diagnostics in centralized laboratories;
medical diagnostics, especially protein diagnostics for cardiology, infectious diseases and/or oncology;
food diagnostics;
environmental diagnostics;
metabolomics; and
flow control.
